(19) United States
(12) Patent Application Publication
(10) Pub. No.: US 2025/0107616 A1
(43) Pub. Date: Apr. 3, 2025

(54) GRILL BRUSH WITH INTERCHANGEABLE HEADS

(71) Applicant: DotekiBrush, South Barrington, IL (US)

(72) Inventors: Madeleine Jongeun YOON, South Barrington, IL (US); Nishka Ajit KOLHE, Barrington, IL (US); Aidan Emilio MARCHESE, South Barrington, IL (US); Grahme Mitchell VALSKIS, Lake Barrington, IL (US)

(21) Appl. No.: 18/675,281

(22) Filed: May 28, 2024

Related U.S. Application Data
(60) Provisional application No. 63/586,866, filed on Sep. 29, 2023.

(51) Int. Cl. A46B 5/00; A47J 37/07; A47J 43/28

(52) U.S. Cl. CPC A46B 5/0095; A47J 37/0786; A47J 43/288; A46B 2200/3073

(57) ABSTRACT

A grill brush assembly including a handle having a holding end and a connecting end with at least one aperture in the connecting end, a lock metal spring clip inserted into the aperture, and at least one brush head or tool having an opening into which the connecting end of the handle fits, and the brush head or tool has at least one aperture configured to receive the lock metal spring clip. This design allows interchangeability of the handle with various brush head and tool designs.

### BACKGROUND OF THE INVENTION

The present invention pertains generally to cleaning brushes and, more specifically, to a grill brush with interchangeable heads.

A commonly utilized tool for cleaning grills involves cleaning brushes. The standard design is a grill brush that has a continuous design from the handle to the brush head. This design permits the top, sides, and between the grates to be cleaned by applying the bristles of the cleaning brush in a back-and-forth motion onto the surface. While typical grill brushes consist of bristles embedded into the brush head, owners of flat top grills may use a scraper cleaning tool to rid their grilling surface of gunk and debris. An effective clean of the grilling surface is imperative to reduce deposition of bacteria on food and to prevent grill fires. However, both standard grill brushes and scrapers can wear out rapidly after repeated use. Either the bristles on the standard brush degenerate from harsh scrubbing or scraper cleaning tools get rusty and brittle from repeated use. Once one brush head deteriorates, it is typical for users to dispose of the entire product due to the continuous design of current grill brushes and tools. Thus, it is costly and wasteful to continuously buy a new grill brush handle and head, specific to the user's grill.

After cleaning the grilling surface, tools such as a spatula and BBQ fork are utilized to facilitate the grilling of foods more easily. With known grill brushes and grilling tools it is inconvenient and excessive to buy and store a wide variety of different tools to clean the grill and cook food. There is thus a need or desire for a grill brush that allows the user to only replace the head once the previous brush head deteriorates while also allowing the user to interchange the types of brush heads and grilling tools with one handle.

### SUMMARY OF THE INVENTION

The disclosed invention relates to a grill brush assembly that includes a handle having at least one aperture on the top end into which a lock metal spring clip is inserted, creating a shank which is configured to allow interchangeability with various brush head and tool designs. The grill brush assembly also includes multiple brush heads and tools that include one aperture where each brush or tool aperture is configured to receive the handle. More particularly, the aperture of the brush head or tool head is configured to receive the shank of the handle. The lock metal spring clip is inserted into the brush head or tool head aperture via a connector mold which provides for easy insertion, removal, and interchangeability of the brush heads and grilling tools. The handle can be inserted and removed from the brush head or tool by squeezing on the lock metal spring clip heads while sliding the handle in or out of the aperture in the brush head end. One advantage of this connector mechanism is that users can easily clean multiple types of grilling surfaces and can conveniently flow from cleaning to grilling to serving with one handle and multiple interchangeable heads. Another advantage of the grill brush assembly is that the assembly enables users to save space when storing their grill brushes and tools, allowing users to store only one handle and a variety of heads.

Various embodiments of the invention include, without limitation, an aluminum handle for forming the grill brush assembly as well as a method of producing a grill brush assembly; a standard brush head used specifically for cleaning grill grates; a scraper head which can be used to scrape off any hard residue; a BBQ fork for serving hot foods; a spatula head used for flipping foods while grilling. Each of these brush heads and grilling tools are interchangeable via a lock metal spring clip, meaning the user will only have to buy one handle and as many heads/tools deemed necessary for their grilling experience. Doing so will allow the user to save money over time, limit waste, and get a more effective clean on their grill.

### BRIEF DESCRIPTION OF DRAWINGS

Various illustrative embodiments of the present disclosure are described herein with reference to the drawings, wherein:

FIG. 1 is a side angle view of a grill brush handle.

FIG. 2 is a side angle view of the grill brush handle with lock metal spring clips in place.

FIG. 3 is a front view of a connector mold for a standard brush head which can receive the shank of the handle in FIG. 2.

FIG. 4 is a side angle view of a grill brush assembly with a standard grill brush head attached to a handle.

FIG. 5 is a side angle view of a standard grill brush head with bristles.

FIG. 6 is a side angle view of a standard grill brush head without the bristles.

FIG. 7 is a side angle view of a grill brush assembly with a scraper head attached to a handle.

FIG. 8 is a side angle view of a scraper head without a connector mold.

FIG. 9 is a side angle view of a scraper head with a connector mold.

FIG. 10 is a side angle view of a grill brush assembly with a spatula head attached to a handle.

FIG. 11 is a top, angled view of a spatula head without a connector mold.

FIG. 12 is a top, angled view of a spatula head with a connector mold.

FIG. 13 is a side angle view of a grill brush assembly with a BBQ fork head attached to a handle.

FIG. 14 is a top, angled view of a BBQ fork head without a connector mold.

FIG. 15 is a top, angled view of a BBQ fork head with a connector mold.

### DETAILED DESCRIPTION OF THE INVENTION

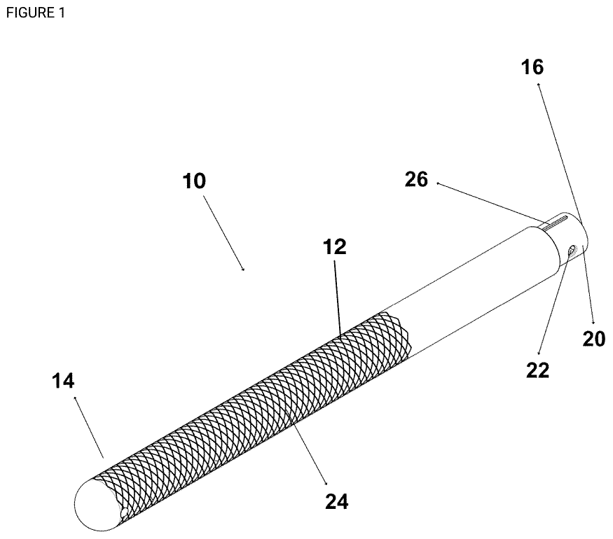

FIG. 1 shows an angled view of a grill brush handle 12 included in the grill brush assembly 10. The figure shows a holding end 14 of the handle 12 at the bottom left corner of the figure and a connector end 16 at the top right corner of the figure. The grill brush handle 12 includes a shank 20 extending from the connector end 16 which is configured to attach to a grill brush 58 or grilling tool head 46, 48, 52, and one or more apertures 22 in a side of the shank 20. The overall handle 12 may have a length between about 14 and about 18 inches, for example. The handle 12 can be made out of metal, which may be aluminum, such as Aluminum 6061-T6. The handle 12 may also include a knurling grip 24 engraved into a surface of the handle 12 to provide extra grip on a portion where the user's hand would meet the handle 12. The knurling grip 24 may extend along approximately 8 to 11 inches of the length of the handle 12. Additionally or alternatively, the handle 12 may include a wood or silicone gripping surface along the holding end 14 of the handle 12. The handle may have a round cross-section, or a cross-section of any other suitable shape, such as rectangular, square, or oval.

The shank 20 is slightly smaller in diameter and circumference than the rest of the handle 12 in order to allow a compatible brush head 58 or grilling tool head 46, 48, 52 to be attached. Straight line engravings 26 on the side of the shank 20 can be used to keep the attachment of the brush head 58 or tool head 46, 48, 52 to the handle 12 secure. One or more apertures 22 can be cut into a side of the shank 20 in order to hold a lock spring mechanism, such as a lock metal spring clip 27. For example, a first aperture 22 may extend through the surface of the shank 20 into a hollow recess or opening in the shank 20 and a second aperture 22 may extend through a diametrically opposite surface of the shank 20.

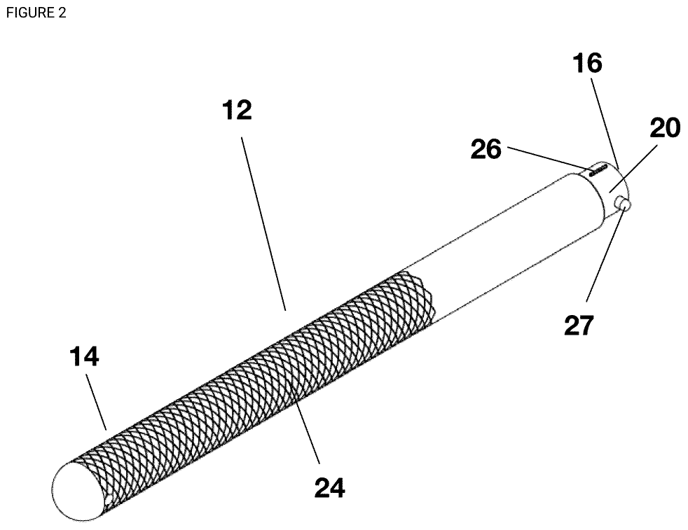

FIG. 2 shows the grill brush handle 12 of FIG. 1 with a lock metal spring clip 27 extending through each of the apertures 22. The lock metal spring clip 27 is used to hold the cylindrical handle opening in place via spring tension, and to refastenably connect the brush head 58 or tool head 46, 48, 52 to the connector end 16 of the handle 12. The lock metal spring clip 27 allows the brush head 58 or tool head 46, 48, 52 to be attached to the handle 12 easily by pressing on the ends of the lock metal spring clip 27, inserting the shank 20 into the brush head 58 or tool head 46, 48, 52, and releasing.

The grill brush assembly 10 can use any of a variety of fastening systems to refastenably connect the brush head 58 or tool head 46, 48, 52 to the connector end 16 of the handle 12. The lock metal spring clip 27 is one option. Other suitable fastening systems include, but are not limited to, a matched pair of threads, a quick-release pin, a bayonet fitting, a ball and sleeve connection, and a cam-lock fitting. Any of these fastening systems can be used in combination with the shank 20 extending from the connector end 16 of the handle 12. For example, the shank 20 can include either male or female threads and an inner surface of a connecting portion of the brush head 58 or tool head 46, 48, 52 can include either female or male threads such that the brush head 58 or tool head 46, 48, 52 can be screwed onto the handle 12. Alternatively, any of these fastening systems can be used in combination with a shank extending from the brush head 58 or tool head 46, 48, 52, in which case, the connector end 16 of the handle 12 can include an opening configured to receive the shank for secure attachment of the brush head 58 or tool head 46, 48, 52 to the handle 12.

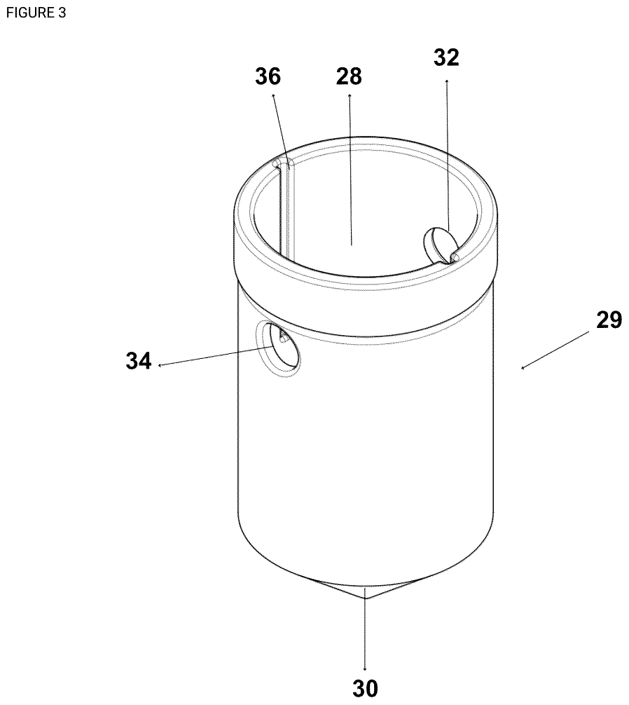

FIG. 3 shows a connector mold 29 for a standard brush head 58 which is configured to receive the shank 20 of the handle 12. The connector mold 29 is suitably made of metal, plastic, or any injection mold filament or other formable material, and is formed as a hollow cylinder with an opening 28 at a first end and a triangular prism 30 at a second end. The connector mold 29 includes a first aperture 32 cut through a side of the cylindrical portion of the connector mold and a second aperture 34 cut through a diametrically opposite side of the cylindrical portion of the connector mold 29. The apertures 32, 34 of the connector mold 29 are the same size as the apertures 22 in the shank 20 of the handle 12 (between 0.25 to 1 inch) in order to allow the lock metal spring clip 27 of the handle to attach to a separate brush head 58 or tool 46, 48, 52. The diameter of the cylindrical opening of the connector mold 29 is slightly larger than the diameter of the shank 20 of the handle 12 in order to allow the shank 20 to be inserted into the connector mold 29. The connector mold 29 may include straight line engravings 36 on an inner surface having approximately the same dimensions as corresponding line engravings 26 on an outer surface of the shank 20 in order to fasten the handle 12 to the brush head 58 or tool head 46, 48, 52 more securely. In addition to the standard brush head 58, the connector mold 29 as shown in FIG. 3 may also be permanently attached to a scraper head, a spatula head, a BBQ fork head, and virtually any other tool accessory head.

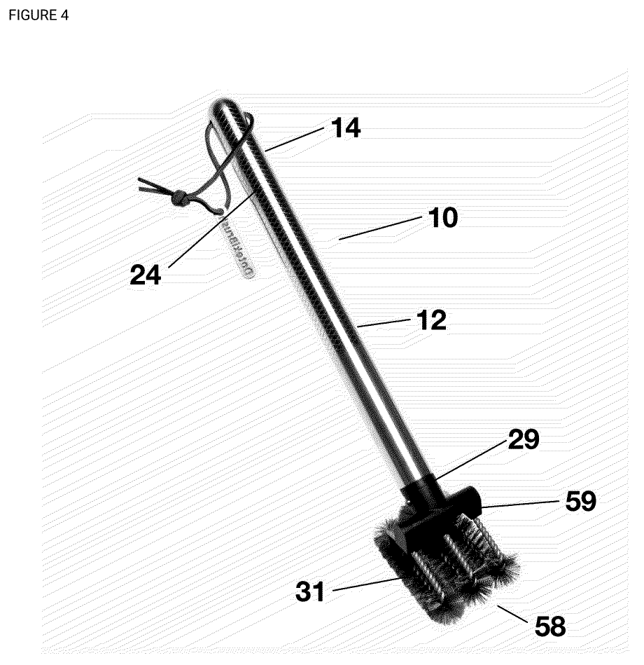

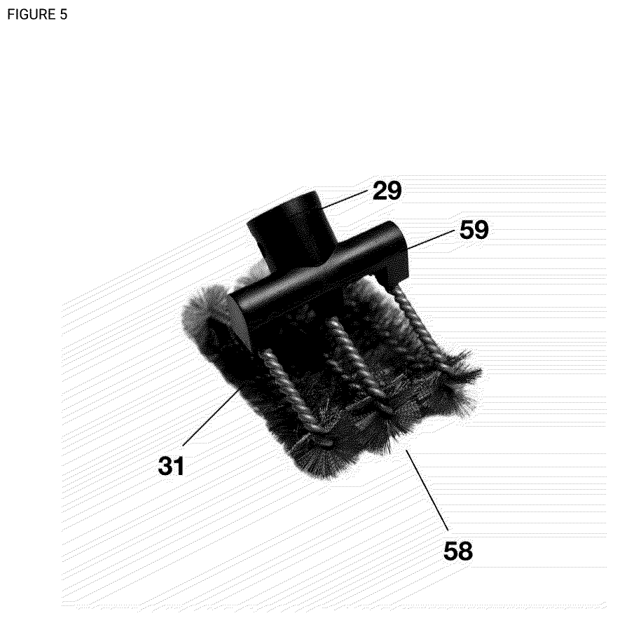

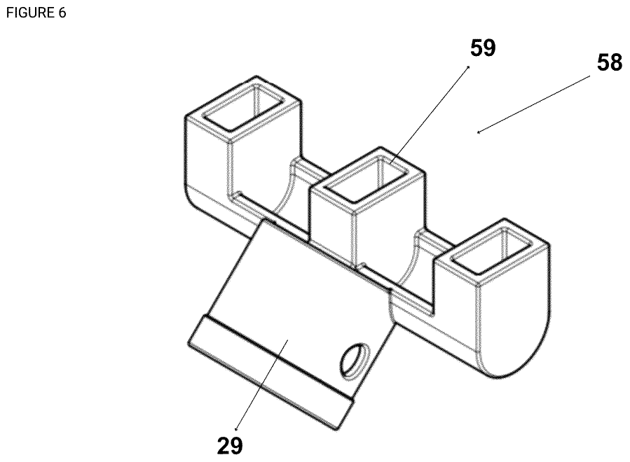

FIG. 4 shows the grill brush assembly 10 with a standard grill brush head 58 attached to the handle 12. FIG. 5 shows the grill brush head 58 by itself. The grill brush head 58 is permanently attached to a connector mold 29 that may have the same design as the connector mold 29 shown in FIG. 3. The grill brush head 58 in FIG. 6 shows just the body of the brush head 58 to which bristles 31 can be attached. The grill brush head 58 suitably has a length between about 3 and 6 inches and a width between about 0.5 and 2 inches, which may include two or more rectangular bristle holders 59 each having a length between about 1 and 2 inches and a width between about 1 and 4 inches. The connector mold 29 in FIGS. 5 and 6 works in the same way as the connector mold 29 in FIG. 3 wherein the shank 20 of the handle 12 is compatible to fit within the standard brush head connector mold 29. A bristle base from which a bristle brush extends, as shown in FIG. 5, can be molded or otherwise permanently attached to the connector mold 29. The bristle brush is located where the brush head 58 is intended to make contact with a grilling grate.

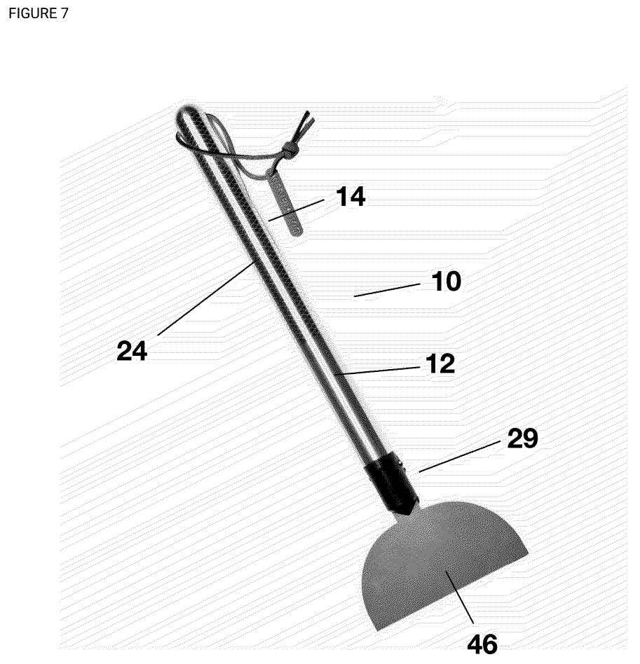

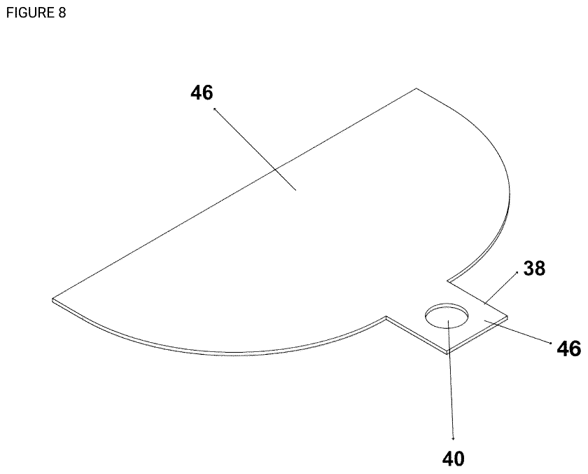

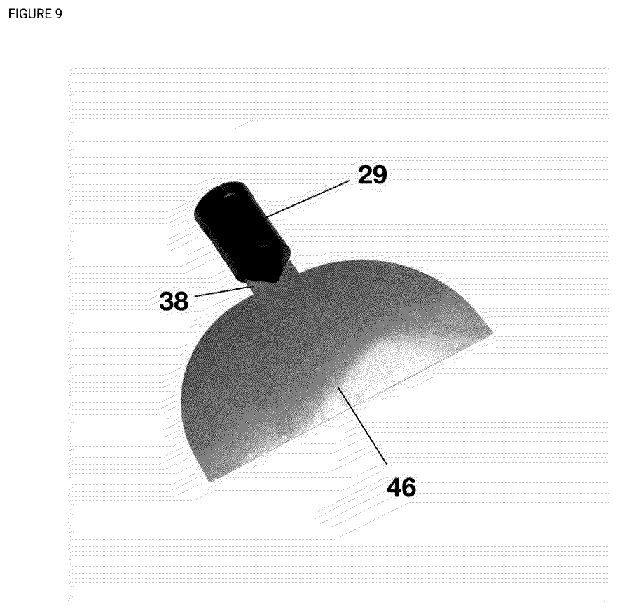

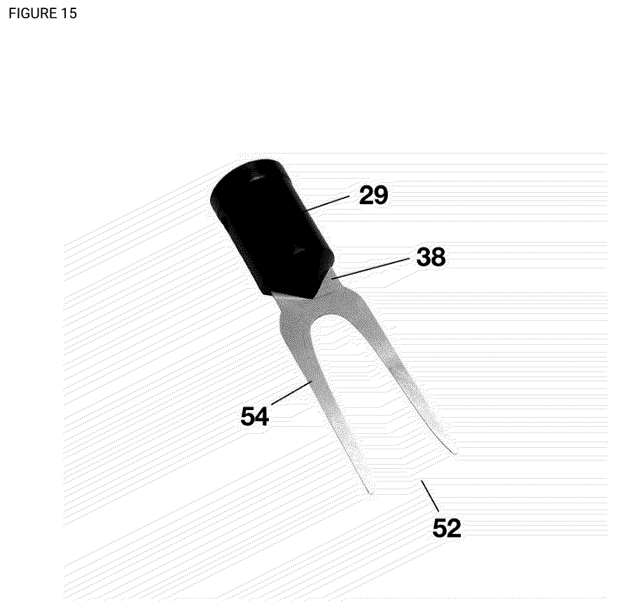

FIG. 7 shows the grill brush assembly 10 with a grill tool scraper head 46 attached to the handle 12. FIG. 8 shows a grill tool scraper head 46 by itself. The scraper head 46 includes an extension 38 extending from an edge of the scraper head and having a hole 40 in the extension 38. The extension 38 may either be angled, as shown in FIG. 15, or flat, as shown in FIG. 8. The extension 38 may have dimensions of approximately 1 inch by 1 inch, or otherwise configured for a connector mold 29 to become permanently attached. The grill tool scraper head 46 may be formed of metal, such as stainless steel 440c, polished finish. The grill tool scraper head 46 may have a length between about 5 and 7 inches with the extension 38 permanently attached to a connector mold 29, as shown in FIG. 9.

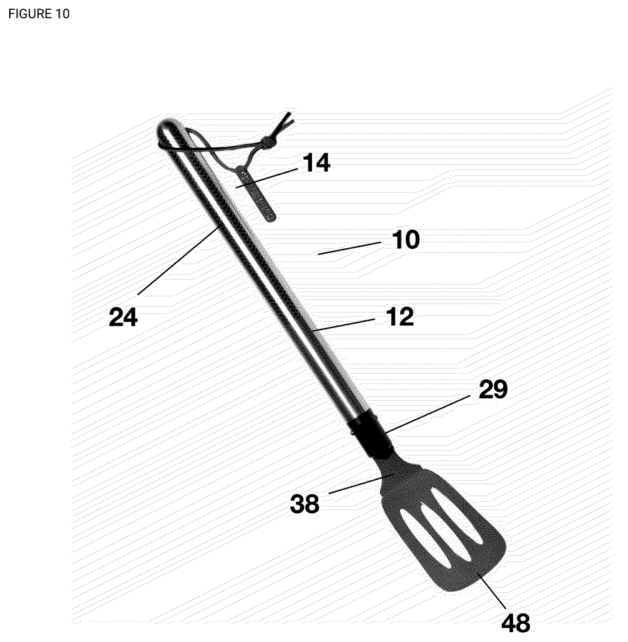

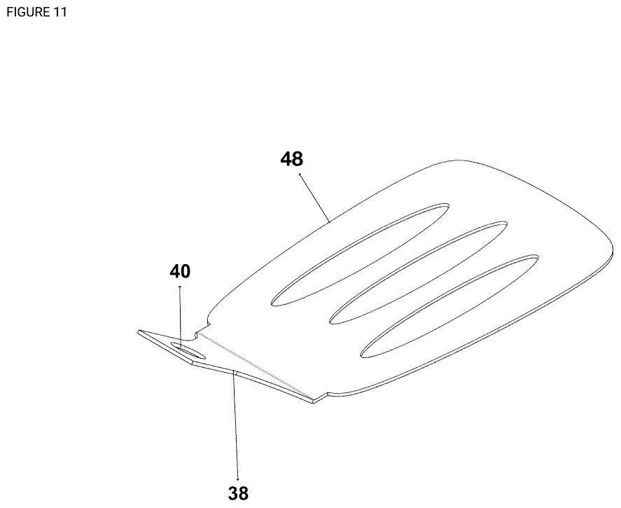

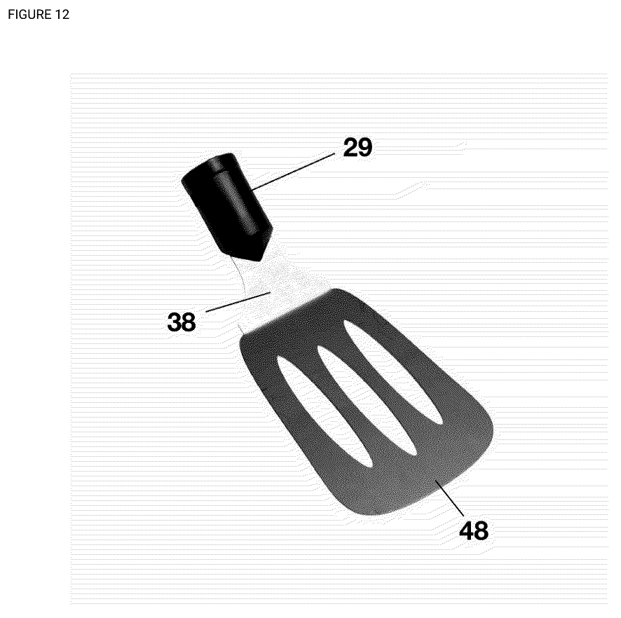

FIG. 10 shows the grill brush assembly 10 with a grill tool spatula head 48 attached to the handle 12. FIG. 11 shows a grill tool spatula head 48 by itself. Similar to the scraper head 46, the grill tool spatula head 48 also includes an extension 38 extending from an edge of the spatula head and having a hole 40 in the extension 38. As in the embodiments of the other tool heads, the extension 38 is designed to become permanently attached to a connector mold 29, as shown in FIG. 12. The length of the extension 38 is suitably between about 3 and 5 inches. The grill tool spatula head 48 may be formed of metal, such as stainless steel 440c, polished finish.

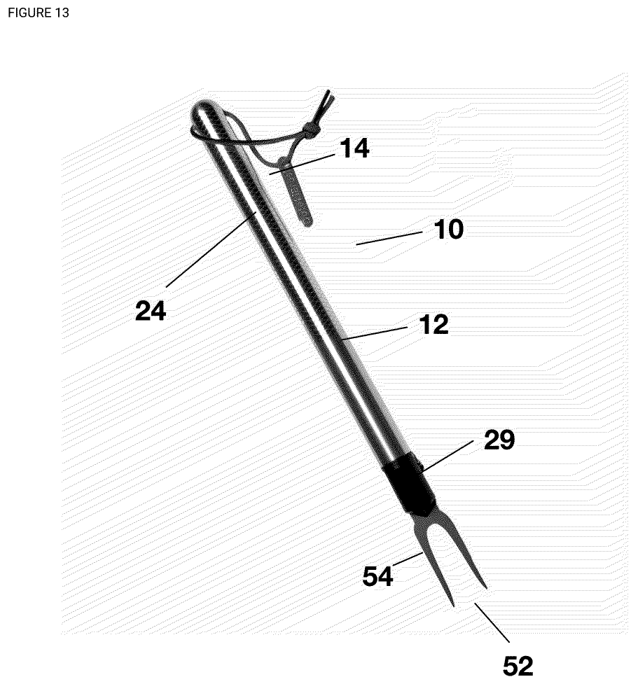

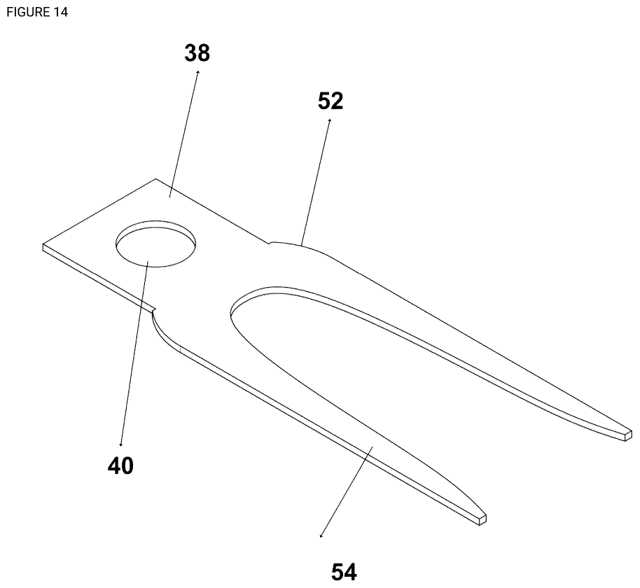

FIG. 13 shows the grill brush assembly 10 with a BBQ fork head 52 attached to the handle 12. FIG. 14 shows a BBQ fork head 52 by itself. Similar to the scraper head 46 and the grill tool spatula head 48, the BBQ fork head 52 also includes an extension 38 extending from an edge of the spatula head and having a hole 40 in the extension 38. As explained above, the connector mold 29 can be molded over the extension 38, thereby permanently securing the BBQ fork head 52 to the connector mold 29, as shown in FIG. 15. The connector mold 29 can then be refastenably attached to the handle 12. Each prong portion 54 of the BBQ fork head 52 may be 2 to 4 inches in length and the extension 38 may be 0.5 to 2 inches in both length and width. The BBQ fork head 52 may be formed of metal, such as stainless steel 440c, polished finish.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

1. A grill brush assembly comprising:
a handle having a holding end and a connecting end, with at least one aperture in the connecting end of the handle;
a lock metal spring clip inserted into the at least one aperture of the handle; and
at least one brush head or tool having an opening into which the connecting end of the handle fits, and the at least one brush head or tool has at least one aperture configured to receive the lock metal spring clip.

2. The grill brush assembly of claim 1, further comprising a shank extending from the connecting end of the handle with at least one aperture extending through a side of the shank.

3. The grill brush assembly of claim 2, wherein the at least one brush head is a standard brush head having an opening configured to receive the shank of the handle.

4. The grill brush assembly of claim 2, wherein the standard brush head comprises a connector mold having an opening configured to receive the shank of the handle.

5. The grill brush assembly of claim 1, comprising more than one brush head or tool, wherein each of the brush heads or tools are interchangeably attachable to the handle.

6. The grill brush assembly of claim 1, wherein the tool is selected from the group consisting of a standard bristle head, a spatula head, a scraper head, and a BBQ fork head.

7. A grill brush assembly comprising:
a handle having a holding end and a connecting end;
at least one brush head or tool; and
a fastening system that refastenably connects the at least one brush head or tool to the connecting end of the handle.

8. The grill brush assembly of claim 7, wherein the fastening system includes at least one of the group consisting of: a lock metal spring clip, a matched pair of threads, a quick-release pin, a bayonet fitting, a ball and sleeve connection, and a cam-lock fitting.

9. The grill brush assembly of claim 7, wherein the fastening system includes a lock metal spring clip inserted into an aperture at the connecting end of the handle, and the at least one brush head or tool has an opening into which the connecting end of the handle fits, and the at least one brush head or tool has at least one aperture configured to receive the lock metal spring clip.

10. The grill brush assembly of claim 7, further comprising a shank extending from the connecting end of the handle, and the at least one brush head or tool includes an opening configured to receive the shank of the handle.

11. The grill brush assembly of claim 7, further comprising a shank extending from the at least one brush head or tool, and the connecting end of the handle includes an opening configured to receive the shank of the at least one brush head or tool.

12. The grill brush assembly of claim 7, comprising more than one brush head or tool, wherein each of the brush heads or tools are interchangeably attachable to the connecting end of the handle.

13. The grill brush assembly of claim 7, wherein the tool is selected from the group consisting of a standard bristle head, a spatula head, a scraper head, and a BBQ fork head.

14. A method of producing a grill brush assembly, comprising:
providing a handle having a holding end and a connecting end;
providing at least one brush head or tool; and
providing a fastening system that refastenably connects the at least one brush head or tool to a connecting end of the handle.

15. The method of claim 14, wherein the fastening system includes at least one of the group consisting of: a lock metal spring clip, a matched pair of threads, a quick-release pin, a bayonet fitting, a ball and sleeve connection, and a cam-lock fitting.

16. The method of claim 14, wherein the fastening system includes a lock metal spring clip inserted into an aperture at the connecting end of the handle, and the at least one brush head or tool has an opening into which the connecting end of the handle fits, and the at least one brush head or tool has at least one aperture configured to receive the lock metal spring clip.

17. The method of claim 14, wherein the handle comprises a shank extending from the connecting end of the handle, and the at least one brush head or tool includes an opening configured to receive the shank of the handle.

18. The method of claim 14, wherein the at least one brush head or tool comprises a shank, and the connecting end of the handle includes an opening configured to receive the shank of the at least one brush head or tool.

19. The method of claim 14, comprising providing more than one brush head or tool, wherein each of the brush heads or tools are interchangeably attachable to the connecting end of the handle.

20. The method of claim 14, wherein the tool is selected from the group consisting of a standard bristle head, a spatula head, a scraper head, and a BBQ fork head.
